(19) United States
(12) Patent Application Publication
(10) Pub. No.: US 2026/0162233 A1
(43) Pub. Date: Jun. 11, 2026

(54) COMPUTER-IMPLEMENTED OPERATING METHOD FOR HANDLING WORK-PIECES BY AN INPAINTING MODEL RECONSTRUCTION OF OCCLUDED PARTS

(71) Applicant: SIEMENS AKTIENGESELLSCHAFT, München (DE)

(72) Inventors: Alexander Köbler, Nürnberg (DE); Harald Funk, Neunkirchen a. Br. (DE); Tobias Pfeifer, Bayreuth (DE); Robert Schmeißer, Schwarzenbruck (DE); Yucheng Liao, Nürnberg (DE); Ralf Gross, Allersberg (DE); Ingo Thon, Grasbrunn (DE); Michael Fiedler, Fürth (DE)

(21) Appl. No.: 18/709,024

(22) PCT Filed: Nov. 8, 2022
(86) PCT No.: PCT/EP2022/081083

§ 371 Date: May 9, 2024

(30) Foreign Application Priority Data
Nov. 10, 2021 (EP) 21207594.9

(51) Int. Cl. G06T 5/77; B65G 47/90; G06T 5/60

(52) U.S. Cl. CPC G06T 5/77; B65G 47/905; G06T 5/60; G06T 2207/10028; G06T 2207/20081; G06T 2207/20084; G06T 2207/20212; G06T 2207/30164

(57) ABSTRACT

A system includes a perception system and a processing function including a camera. A vision system processes data from the camera. The system takes the camera data and reconstructs occluded parts to reestablish a violated prior assumption needed for a downstream system. The system is to be trained to reconstruct incomplete information in a sequence of images. The training may be based on historic knowledge or on simulated data.

This application is the National Stage of International Application No. PCT/EP 2022/081083, filed Nov. 8, 2022, which claims the benefit of European Patent Application No. EP 21207594.9, filed Nov. 10, 2021. The entire contents of these documents are hereby incorporated herein by reference.

### BACKGROUND

In an automation facility, workpieces are handled and processed in order to form products from the workpieces.

Industrial robot systems are widely used in this automation facilities for different tasks. The industrial robot systems are automated, programmable, and capable of movement on three or more axes and therefore may assist in material handling. Typical applications of robots include welding, painting, assembly, disassembly, pick and place, packaging and labeling, palletizing, product inspection, and testing are all accomplished with high endurance, speed, and precision.

It is a common task for a robot to pick some object from a transportation device (e.g., a conveyor belt or an autonomous transportation vehicle) for transport and further processing.

It is also possible that a workpiece is placed fixed, and the processing stations are doing the movement.

In the further text, work-station is not only a robot but may be any kind of kinematic or handling system.

Perception system (e.g., camera) data includes all kinds of sensor scanning data, not only visual data. Within the field of 3D object scanning, laser scanning combines controlled steering of laser beams with a laser rangefinder. By taking a distance measurement at every direction, the scanner rapidly captures the surface shape of objects. 3D object scanning allows enhancing the design process, speeds up and reduces data collection errors, saves time and money, and thus makes it an attractive alternative to the above mentioned traditional data collection techniques.

By utilizing this perception system, data processed by Artificial Intelligence (AI), Machine Learning, or classical computer vision enables many novel applications on the shop floor. Examples include, grasping of known objects, flexible grasping of unknown objects, quality inspection, object counting, and many more.

These functionalities often come in the form of black boxes, which consume perception system images from a standardized interface, either talking directly to the perception system (e.g., via GigE Vision, USB vision, Firewire) or via proprietary protocols such as ZeroMQTT or MQTT, https://mqtt.org/.

The black box function is then producing a result that is consumed by a downstream system (e.g., for picking an object from a conveyor belt).

These black box functions are always developed with a specific scenario in mind. If assumptions of this scenario are violated, the functionality cannot be used and is to be redeveloped.

A typical example of such a violation is the situation when parts are transported on, for example, a conveyor belt for further processing, where these parts are partially positioned such that these parts obscure other parts.

This situation is depicted in FIG. 3, where a conveyor belt 211 is equipped with a separation device 212 (e.g., a brush). Workpieces 201 are placed on this conveyor belt and transported towards the robot 221. In the shown case, two workpieces are situated on top of each other, so that scanning devices 222, 223 cannot recognize only a fraction of the lower object and in worst case cannot differentiate both objects. A first perception system (e.g., a camera 222) or a second perception system (e.g., a laser scanner 223 with its linear scanning 224) will only recognize one part (e.g., that lies on top), and the robot 221 will therefore discard the workpieces.

Instead of a conveyor belt transporting the workpiece to a robot, alternatively, the robot may be somewhat mobile and moves toward the workpiece (e.g., including the perception system).

So far, it was necessary to re-establish the assumptions imposed from the original system. In case of the aforementioned picking example, this requires attaching the perception system/camera 222 at the right spot to remove occlusions by the machinery. Further, when occlusion of an object happens due to objects 201 lying on top of each other, the scenery is to be scanned multiple times, and occluding objects are to be removed iteratively. Alternatively, sometimes mechanical devices 212 may be used to solve the issue. Lastly, pieces that cannot be processed may be disregarded.

However, all these steps imply extra costs and extra time.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method and a system that may handle the situation described above without the need of multiple scanning is provided.

A computer-implemented operating method for operating a work-station in an industrial facility that is furnished and suitable for processing workpieces is provided. The workpieces in the facility are transported in direction to the work-station, or the work-station is moved towards the workpieces. The work-station is suitable and equipped to pick up the workpieces, and during transport, the workpiece are scanned by a perception system to produce scanning data from the workpieces. The evaluation of the scanning data shows that a second workpiece is positioned such that the second workpiece is occluded from being completely scanned by the scanning equipment.

In a next act, the occluded part of the second workpiece in the scanning data is reconstructed by using an inpainting process on the received scanning data, based on a trained model using training data. The work-station then removes workpieces by first picking the first recognized workpiece, and then picking the second workpiece for further processing in the industrial facility.

A possibility of detecting the scanned workpieces even when the scanned workpieces are at least partially occluded is provided.

This is done by reconstructing the occluded part of the second workpiece in the scanning data by using an inpainting process on the received scanning data, based on a trained model using training data.

Inpainting as such is known as a process where damaged, deteriorating, or missing parts of an artwork are filled in to present a complete image. There are programs in use that are able to reconstruct missing or damaged areas of digital photographs and videos. Inpainting has become an automatic process that may be performed on digital images. More than mere scratch removal, the inpainting techniques may also be applied to object removal, text removal, and other automatic modifications of images and videos.

In the following, we describe also a system that re-establishes the respective assumptions in a special case using artificial intelligence functions. An example of such a prior assumption is given by the need for the absence of occlusion in the context of automated picking. Occlusions of objects to be picked may be given due to the machinery or due to other objects.

### BRIEF DESCRIPTION OF THE DRAWINGS

FIG. 1 is an example of a data cloud after a scanning process;

FIG. 2 is an example of reconstruction of a lower part by using an autoencoder;

FIG. 3 is an example of an industrial facility with a work-station;

FIG. 4 is a possible solution concept; and

FIG. 5 is a data processing concept for the solution.

### DETAILED DESCRIPTION

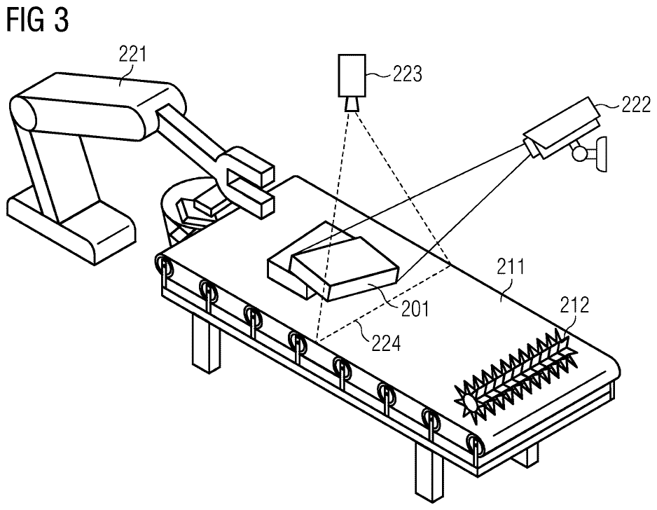

FIG. 3 shows an example situation, where the described method will be deployed. The details of FIG. 3 are already described in the introduction of the text, as one main advantage of the present embodiments is the possibility to introduce this on already existing systems without great effort.

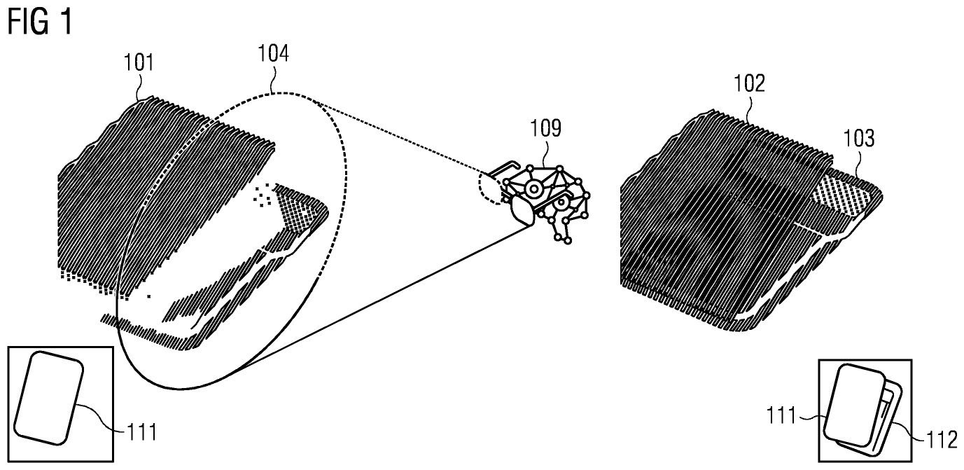

FIG. 1 shows the main problem of the existing systems on the left side. While scanning multiple objects 101 placed on top of each other to be processed, at the moment, it is not possible to catch a view on a bottom object. During the process of scanning the objects 104, for example, with a laser scanner 109 to create a 3D point cloud, only the object on the top will be recognized 111 for further processing. The object below will not be recognized. This will slow down the production process, as the perception system got an image 111 that gives the impression of the bottom object missing and in worst case discards the objects or stops the system.

It is a task of the present embodiments to offer a solution for the described problem by offering a possibility to detect the situation correctly and show not only the object on the top 111 but also the object below 112.

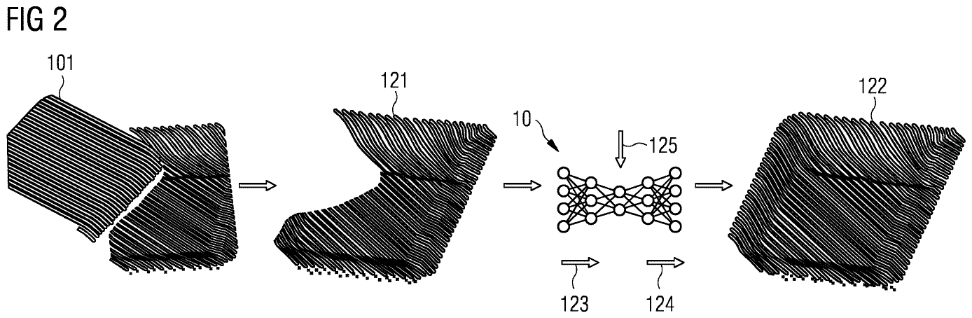

FIG. 2 shows the result of the scanning process done by the scanning equipment, as a camera 222 or a laser scanner 223. The scanning process in the example is a line by line scanning, and the result is in this case a 3D point cloud, as depicted in the left picture.

Before the further processing, and depending on the scanning method used, a noise reduction may be applied on the scanning result. The term noise reduction denotes the process of removing noise from a signal. Noise reduction techniques exist not only for audio but also for image data. Noise reduction algorithms may distort the signal to some degree.

All signal processing devices, both analog and digital, have traits that make the signal processing devices susceptible to noise, providing disturbances in the reception.

Noise reduction processes may be supplemented even to the extent that additional correctly recognized things are filtered out as “noise”, which are recognized but not relevant for further processing.

In a first act of the processing, the two workpieces are differentiated between, and then the information that belongs to the workpiece lying on top is deducted.

In the second picture, what then is left of the scanning result 121 and which is assumed to belong to the lower workpiece is shown. In the next act, for example, by using autoencoder technology 10 (e.g., with Encoding act 123 and Decoding act 124), there will be an output generated 122, where the missing parts are added in this step and as a result shows the lower work piece in total 122 for further processing.

An autoencoder is a type of artificial neural network used to learn efficient coding of data. The encoding is validated and refined by attempting to regenerate the input from the encoding. Generally, an autoencoder learns a representation (e.g., encoding) for a set of data (e.g., for dimensionality reduction) by training the network to ignore insignificant data (e.g., “noise”).

In the following, the autoencoder is used in two different ways: In the case of inpainting, the encoding is validated and refined by attempting to regenerate the missing information in the input and comparing the regenerated missing information to its ground truth counterpart. The trained model may further be used to regenerate the missing information in previously unseen inputs.

Further, autoencoders may be used for the segmentation of different objects in an input.

In one embodiment, during the training, the input data and corresponding categories are to be provided. The objective is given by recreating the input with assigned class affiliations of single points.

This approach turns out to be advantageous in the view of resource saving.

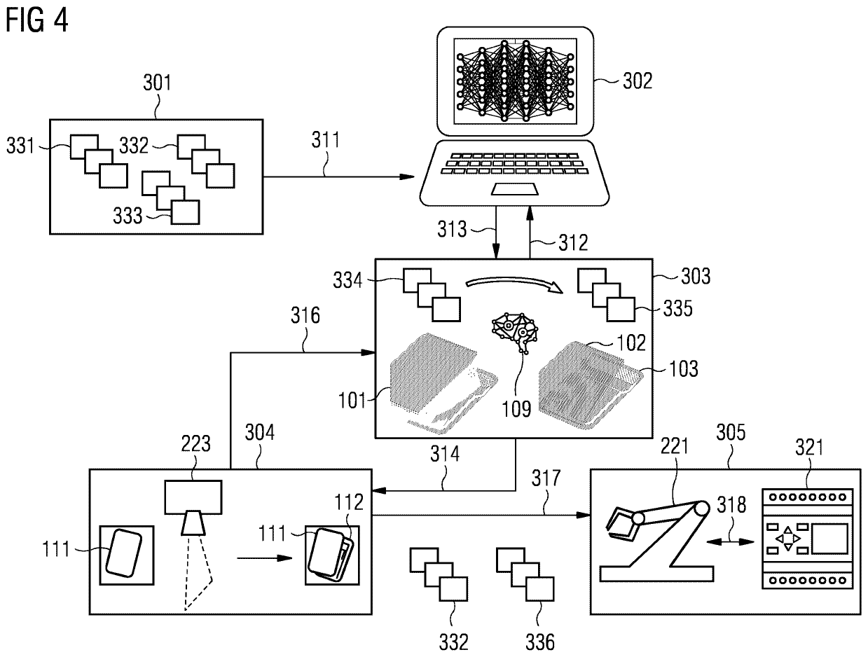

FIG. 4 shows a solution concept of the method and system depicted on a total system, including the already known parts also.

In the middle 303, the same symbolic picture as in FIG. 1 is shown. From the Workpieces 201, there are scanned 3D point clouds 101. The scanned 3D point clouds 101 are transformed by the proposed method 109 to reconstructed data 335 that contains information about the top and the reconstructed bottom part. This is symbolized by the reconstructed 3D point cloud with both parts 102, 103.

In the beginning, there is the classic vision system 223 depicted in box 304. The classic vision system 223 scans the workpieces, and if there is no problem and the workpieces are situated as expected on the transportation medium, no more action is required. The information is passed to the processing system 305 with programmable logic controller (PLC) 321 that controls 318 a robot 221 (or any other gripping device). The Information 317 that is transferred from the Vision System 304 to the Execution System 305 contains separate information about lower object(s) 332 and upper object(s) 336.

In the case that the vision system 304 detects a situation with the lower object partly occluded by the upper object, the information about this will be directed to the new system 316, which then evaluates the information as described above.

There is one initial dataset creation 301 to train a model 302 initially and later, also continuously during execution of the system and method. The dataset starts with 3D point cloud information for the lower objects 332, both objects 331, and labels 333 for the model that was trained on machine learning methods.

The training may also be refined by further data that was collected from the real system, 312, 313 later on.

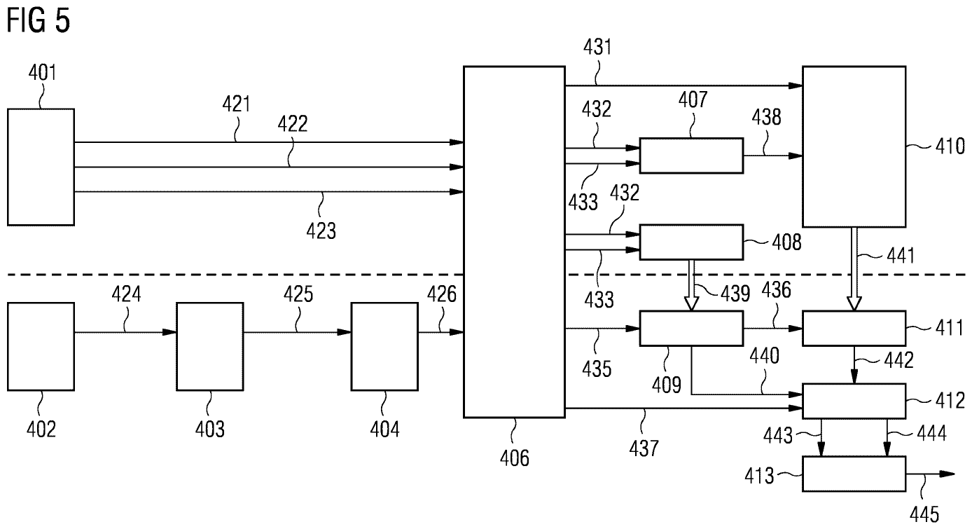

FIG. 5 describes the data processing concept of the solution of the present embodiments in more detail.

Top left we start with synthetic training data 401, which includes information about ground truth hidden object point clouds 421, Point Clouds with Both Objects 422, and Categories Point clouds 423. The synthetically generated point cloud of the complete lower object consists of the occluded and the non-occluded part (122). The synthetically generated point clouds of both objects consist of the complete upper object and the non-occluded part of the lower object (see 101).

Below is a second path for producing training data using real data 402 that is created during the execution of the real system. The information about repoint clouds with Both Object are then revised 424 by cropping the background 403 (e.g., with a fixed y and z cropping boundary) and then 425 by removing additional noise by application of an outlier removal algorithm 404.

Those are then computed via Interpolation 406, regarding
Grid=Grid
Depth Map Dimension 405
Fixed maximal Euclidian distance and linear interpolation

The point clouds are mapped 406 to an equidistant grid 437 by mapping the points to their nearest neighbor in the grid within a predefined maximal Euclidian distance and subsequent interpolation.

Afterwards, the point clouds are denoted as depth maps.

The categories 422 are also mapped to the equidistant grid yielding 433.

In other words, the upper path, starting with synthetic data 401, describes the training process of the system (e.g., the training based on this synthetic data). The training data 401 on the top left consists of the point cloud of the complete lower object consisting of the occluded and the non-occluded part 421 (see FIG. 2), the point clouds of both objects consist of the complete upper object and the non-occluded part of the lower object 422 (see 101), and the categories with respect to the point clouds with both objects 422. The categories differentiate between points corresponding to the upper object and points corresponding to the non-occluded part of the lower object.

The lower path, starting with real data 402, shows the data processing of real data of the in production deployed system. This data consists of the point cloud recorded by the real system with the upper object and the non-occluded part of the lower object 424. These point clouds are then revised 424 by cropping the background 403 (e.g., with a fixed y and z cropping boundary) and then 425 removing additional noise by application of an outlier removal algorithm 404.

The point clouds are interpolated to an equidistant grid 406, and after, denoted as depth maps. The categories 422 are also mapped to the equidistant grid yielding 433.

In the depth map 432 generated from the point cloud 422 including both objects, the upper object is masked by a constant 407 using the categories 433 yielding the masked depth map 438.

A convolutional autoencoder 410 may be trained for inpainting using the depth map generated of 421 of the complete lower object 431 and the masked depth map 438.

A second autoencoder is trained with the depth map of both objects 432 and the categories 433 to segment the upper and the non-occluded part of the lower object in the depth map 432.

The trained inpainting autoencoder 411 is deployed 441 in the real system.

The trained segmentation autoencoder 409 is deployed 439 in the real system.

In the deployed real system, the filtered point clouds 426 are mapped to the equidistant grid 437, yielding the depth map including the upper and the non-occluded lower object 435.

The depth map 435 is segmented using the trained segmentation autoencoder 409 yielding the depth map 436 with masked upper object and the depth map 440 only consisting of the upper object.

The masked depth map 436 is inpainted using the trained inpainting autoencoder 411, yielding the depth map 442 with the complete reconstructed lower object.

The depth maps 442 and 440 are reconstructed to 3D point clouds 443 and 444, respectively, utilizing the equidistant grid 437.

The reconstructed point cloud of the lower object 443 and the point cloud of the upper object 444 are recombined 413 to a single point cloud without missing values because of occlusion 445.

The combined point cloud 445 may be transferred as a . tif-file and be further processed in the facility (e.g., by the base vision system).

In summary, the system assumes the following components: a perception system (e.g., a laser scanner or a camera); a processing function (e.g., one or more processors); and a vision system that processes the data from the camera.

This base system is extended as described. The base system takes the camera data and reconstructs occluded parts to reestablish the violated prior assumption for the downstream system.

The system is to be trained to reconstruct incomplete information in the sequence of images. The training may be based on historic knowledge or on simulated data. The application example shows inpainting of 3D Point Clouds of overlapping objects.

Data may be generated in simulation by the following acts: 1) rebuilding the real setup in a virtual environment, including a point cloud camera, for example; 2a) simulating situations with overlapping objects (e.g., providing variation in relative angles and share of overlap between the objects) in relevant position of the Field of View (FOV) of the point cloud camera; 2b) including data transformation functions to get the same format of point clouds measured by real camera and by a simulated camera (if necessary); 3) data is acquired for different situations in the virtual environment, thereby building a database of samples. Each sample includes: (a) ‘measured 3D point cloud by simulated camera’; (b) ‘ground truth point cloud of the lower object including parts of the object that were hidden from the camera angle by the object overlap’; (c) ‘assignments between points and objects in point cloud (a)’. Alternatively, historical data may be recorded in the real process. Further, the data may be generated in simulation by: 4) training a Machine Learning model for inpainting (MLM1) based on (a) and (b). Thereby, a Machine Learning model may generate (b) out of (a). Further, the data may be generated in simulation by the following acts: 5) training a Machine Learning model for object segmentation (MLM2) based on (a) and (c); 6) deploying MLM1 & MLM2 on the real system; and 7) performing inpainting and segmentation on point cloud as measured by a real camera. Simulated or historical data may be utilized to reconstruct missing information, instead of the costly adaptation of the data recording process, to reduce the preceding information loss.

In summary, the solution achieves the advantages described in the following.

Already existing processes and systems may be reused unchanged. There is no in-depth change required. The new acts may be easily integrated into any existing system.

By using the solution of the present embodiments, the process speed may be increased significantly, because no removal of physical measurement restrictions is necessary. This provides that the amount of unrecognized objects is significantly lower due to the processing of the scanned data by the method of the present embodiments, and the process passes in a larger number of cases with a positive result in the recognition. No stopping of the process is necessary.

An increased process reliability will be provided because cases with missing information due to the measurement may be processed.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for operating a work-station in an industrial facility for processing workpieces, the workpieces including a first workpiece and a second workpiece, the method being a computer-implemented operating method and comprising:
transporting the workpieces in the industrial facility in direction to the work-station, or moving the work-station towards the workpieces, wherein the work-station is configured to pick up the workpieces;
during the transporting, scanning, by a perception system, the workpieces, such that scanning data is produced from the workpieces, the scanning, by the perception system, of the workpieces, such that the scanning data is produced from the workpieces comprising scanning the workpieces with a camera or a laser scanner, such that a three-dimensional (3D) point cloud is created, wherein an evaluation of the scanning data shows that the second workpiece is positioned such that the second workpiece is occluded from being completely scanned by the perception system;
reconstructing an occluded part of the second workpiece in the scanning data using an inpainting process on the received scanning data, based on a trained model using training data;
recombining the reconstructed 3D point cloud of a lower object and the reconstructed 3D point cloud of an upper object to a single point cloud without missing values due to occlusion; and
removing, by the work-station, the workpieces, the removing comprising first picking the first workpiece, and then picking the second workpiece for further processing in the industrial facility.

2. The method of claim 1, wherein another object, is positioned with respect to the second workpiece such that the other object occludes the second workpiece from being completely scanned by the perception system.

3. The method of claim 1, wherein the trained model uses historical data for training purposes, the historical data having been recorded during real processing of the workpieces in advance.

4. The method of claim 1, wherein the trained model uses a simulated data sample set created by rebuilding a real setup in a virtual environment and simulating scanning data, and
wherein the first workpiece is positioned with respect to the second workpiece such that the first workpiece occludes the second workpiece from being completely scanned, by varying an angle of the workpieces and a share of occlusion of the second workpiece.

5. The method of claim 4, wherein scanning information includes the 3D point cloud by the laser scanner, and each training data sample includes:
a measured 3D point cloud by a simulated camera;
a point cloud of the lower object including parts of an object that were hidden from a camera angle by an object overlap; and
assignments between points and objects in the measured 3D point cloud.

6. The method of claim 1, wherein the inpainting process of occluded part of the second workpiece is used for prediction of perception of the second workpiece after picking first workpiece.

7. The method of claim 1, wherein for the an image inpainting process on the scanning data, an artificial neural network autoencoder is used.

8. (canceled)

9. The method for of claim 4, wherein a data transformation function is included to generate a same format of point clouds measured by the perception system and by simulated camera.

10. A data processing system comprising:
a processor configured to operate a work-station in an industrial facility for processing workpieces, the workpieces including a first workpiece and a second workpiece, the processor being configured to operate the work-station comprising the processor being configured to:
transport the workpieces in the industrial facility in direction to the work-station, or move the work-station towards the workpieces, wherein the work-station is configured to pick up the workpieces;
during the transport, scan, by a perception system, the workpieces, such that scanning data is produced from the workpieces, the scan, by the perception system, of the workpieces, such that the scanning data is produced from the workpieces comprising scan of the workpieces with a camera or a laser scanner, such that a three-dimensional (3D) point cloud is created, wherein an evaluation of the scanning data shows that the second workpiece is positioned such that the second workpiece is occluded from being completely scanned by the perception system;
reconstruct an occluded part of the second workpiece in the scanning data using an inpainting process on the scanning data, based on a trained model using training data;
recombine the reconstructed 3D point cloud of a lower object and the reconstructed 3D point cloud of an upper object to a single point cloud without missing values due to occlusion; and
remove, by the work-station, the workpieces, the removal comprising a first pick of the first workpiece, and then a pick of the second workpiece for further processing in the industrial facility.

11. (canceled)

12. (canceled)

13. The method of claim 2, wherein the other object is the first workpiece.

14. In a non-transitory computer-readable storage medium that stores instructions executable by one or more processors to operate a work-station in an industrial facility for processing workpieces, the workpieces including a first workpiece and a second workpiece, the instructions comprising:
transporting the workpieces in the industrial facility in direction to the work-station, or move the work-station towards the workpieces, wherein the work-station is configured to pick up the workpieces;
during the transporting, scanning, by a perception system, the workpieces, such that scanning data is produced from the workpieces, the scanning, by the perception system, of the workpieces, such that the scanning data is produced from the workpieces comprising scanning of the workpieces with a camera or a laser scanner, such that a three-dimensional (3D) point cloud is created, wherein an evaluation of the scanning data shows that the second workpiece is positioned such that the second workpiece is occluded from being completely scanned by the perception system;
reconstructing an occluded part of the second workpiece in the scanning data using an inpainting process on the scanning data, based on a trained model using training data;
recombining the reconstructed 3D point cloud of a lower object and the reconstructed 3D point cloud of an upper object to a single point cloud without missing values due to occlusion; and
removing, by the work-station, the workpieces, the removing comprising first picking the first workpiece, and then picking the second workpiece for further processing in the industrial facility.
